(19) United States
(12) Patent Application Publication
(10) Pub. No.: US 2010/0036752 A1
(43) Pub. Date: Feb. 11, 2010

(54) Method and system for associating a pre-selected order with a customer account via a website for expediting the in-store ordering process and subsequent order fulfillment by way of an internet-connected terminal

(76) Inventors: Sherry Lee Berkin, Palos Verdes Estates, CA (US); Christopher Michael Berkin, Palos Verdes Estates, CA (US); Michael Peter Fox, Parishi Devonshire (BM)

Correspondence Address: LAW OFFICES OF JOSEPH R. CRUSE, JR., 28215 AGOURA ROAD, SUITE 130, AGOURA HILLS, CA, 91301, US

(21) Appl. No.: 12/462,543

(22) Filed: Aug. 5, 2009

Related U.S. Application Data
(60) Provisional application No. 61/188,076, filed on Aug. 6, 2008.

(51) Int. Cl. G06Q 30/00; G06Q 20/00; G06Q 10/00

(52) U.S. Cl. 705/27; 705/26

(57) ABSTRACT

A novel retail method of and system for (a) vendor(s) to enroll store(s) and manage an on-line catalog/menu of available goods/services through use of a website, (b) a customer to pre-select one or more “favorite” orders offered by vendor(s) through the use of a website, (c) a customer to subsequently initiate the ordering of one or more such pre-selected favorite(s) when at an Internet-connected terminal located at such a vendor's premises, with the system connecting one or more of the on-site ordering devices to an application that matches the customer to his/her pre-selected order(s) for the customer to then confirm (or cancel to abort the transaction) the specific pre-selected order to fulfill and alerts the order fulfillment personnel at store from where the order was initiated, and then (d) debits the customer's pre-paid account while providing a means of crediting the vendor providing the goods and/or service.

### FIELD OF THE INVENTION

This invention relates generally to methods and systems for retail ordering and order fulfillment.

### BACKGROUND OF THE INVENTION

Individuals tend to shop at various shops and stores on a regular basis. An individual can become familiar with a store and visit it regularly. Many individuals frequent a certain coffee shop or fast-food restaurant. One of the main complaints made with respect to these types of retail establishments is that the time from entry into the store to fulfillment of purpose (during which a customer (a) often waits on a line, (b) then place his/her order, (c) then waits for it to be prepared and (d) finally pays for that order) can be inordinately long.

The following Invention was conceived primarily based upon the need to dramatically reduce the time needed to conduct a retail in-store ordering (and order fulfillment) process for customers who regularly order one or a small number of different combinations of items. The Invention can reduce to seconds what otherwise might take considerably longer.

While many solutions have been designed to improve the retail ordering process, none address the combined need of customers and vendors to allow for an expedited, repeatable in-store order of a frequently purchased item(s).

Other benefits of this Invention include, without limitation, improved ordering accuracy, the ability for customers and vendors to report on order history, and improved insight into the buying behavior of customers.

### SUMMARY OF THE INVENTION

The Invention allows for the on-site initiation of a pre-selected order at an Internet-connected terminal. One or more ordering devices interact(s) over the Internet to a website that matches the identity of the customer with his/her pre-selected order(s) for the customer to either (a) confirm one pre-selected order or (b) cancel and abort the transaction. A confirmation (a) debits the customer's pre-paid account while providing a means of crediting the vendor providing the goods and/or service and (b) alerts the vendor that the order has been placed so that it may be fulfilled.

One or more vendors will agree to have all or a portion of their respective product and/or service catalogs/menus hosted on the website. Each will have a password protected account and will register one or more store locations. One or more terminals will be installed at each such registered store location. The website will allow a vendor to manage his/her account, including modifying catalog/menu selections, adding and managing data related to registered stores, managing available stock keeping units, reporting on recent purchases and making related information available to personnel at each related store location (e.g., in the case of chains or franchises).

In order to utilize the Invention, a customer will register by visiting the website, opening a password protected account, establishing a means of identification, and creating and funding a customer account (which can be further funded in the future). The website will allow the customer to locate participating vendors and stores. The customer may choose one or more products as his/her pre-selection for each participating vendor; potentially, the opportunity to confirm for fulfillment more than one such pre-selection for any given in-store transaction will be offered, though it is anticipated that customers will not have the ability to pre-select many combinations of products, as customers faced with too many choices during the order initiation process described in paragraphs 0010 through 0012 would likely slow the process and negate some of the time-saving benefit of the Invention. The customer may return to the website to change his/her pre-selection(s) for any participating vendor as often as he/she wishes. Additionally, order history may be available on the website.

On any occasion when the customer visits a registered store of a vendor for which that customer has made one or more pre-selections, that customer need not wait in the traditional order line to place his/her order. Instead, the customer will proceed directly to a terminal and swipe a credit card or other card with a terminal-readable identifying stripe that may serve as identification such as a debit card, government issued ID, etc., or undergo a different electronic identity confirmation process.

Once the customer's identity is established, the description of his/her pre-selection(s) for that store/vendor (previously configured by that customer through his/her customer account) will appear on the screen (or other display/output device) along with the price of the items comprising the pre-selection(s) (except in the case of a pre-selection that is not available at that store location in which case the customer would be so notified). Provided there are sufficient funds in the customer's customer account, the customer will be prompted to confirm or (if the customer has configured more than one pre-selection related to that vendor/store) choose the desired pre-selection.

If the customer confirms/chooses a pre-selection, the terminal will transmit a subsequent communication to the website. Immediately upon confirmation of a successful purchase request, the Invention will (a) return a purchase confirmation message at the terminal, (b) print or otherwise communicate the requested purchase to appropriate store personnel so that the order can be filled, (c) debit the customer account by the cost of the order and (d) credit the vendor account with the appropriate sum (or properly account for the transaction so that such credit will be applied later). If the customer cancels the order before confirming it at the terminal or if his/her customer account has insufficient funds (and the customer chooses not to or is unable to increase his/her account balance while at the terminal, if such choice is provided), then (a) such information will be conveyed at the terminal, (b) no order fulfillment information will be provided to store personnel, (c) the customer account will not be debited and (d) the vendor account will not be credited with respect to the aborted transaction at any time.

### DRAWINGS—FIGURES

FIG. 1 is a schematic diagram of a high-level method and system overview.

FIG. 2 is a schematic diagram of a high-level system overview of the website and its major components.

FIG. 3 is a schematic diagram of the third-party payment gateway.

FIG. 4 is a schematic diagram of the In-Store Internet-Connected Terminal and its components.

FIG. 5 is a flow chart relating to a logical system view of a high-level method and system overview.

### DETAILED DESCRIPTION

The detailed description set forth below in connection with the drawings is intended as a description of presently preferred embodiments of the Invention and is not intended to represent the only forms in which the present Invention may be constructed and/or utilized.

The Invention allows for the on-site initiation of a pre-selected order at an Internet-connected terminal. One or more ordering devices interact(s) over the Internet with a website that matches the identity of the customer with his/her pre-selected order(s) for the customer to either (a) confirm one pre-selected order or (b) cancel and abort the transaction. A confirmation (a) debits the customer's pre-paid account while providing a means of crediting the vendor providing the goods and/or service and (b) alerts the vendor that the order has been placed so that it may be fulfilled.

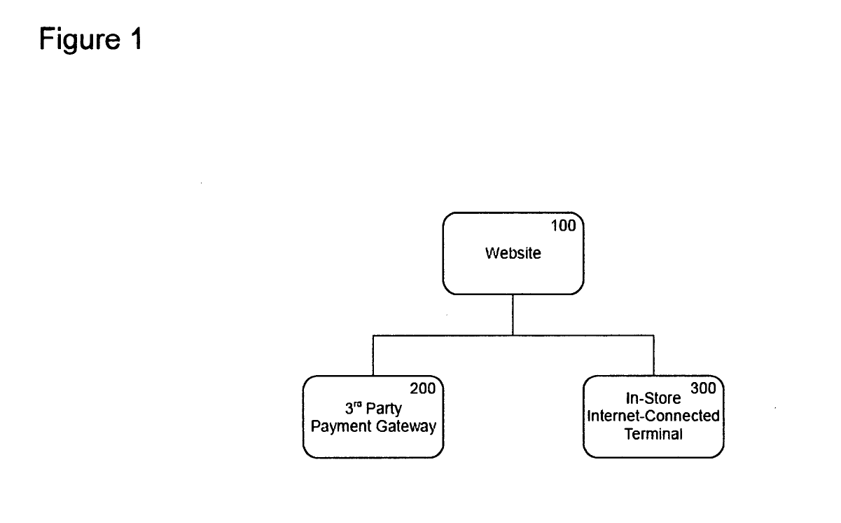

FIG. 1 displays a schematic diagram of a high-level method and system overview of the present Invention containing a website (100), 3^{rd} Party Payment Gateway (200) and an In-Store Internet Connected Terminal (300). The purpose of FIG. 1 is to highlight the three distinct components: a website located apart from the in-store terminal which in turn is located apart from the 3^{rd} party payment gateway. Communication between these components would occur as transmissions over the public Internet (most likely using web services). If initial transmission from an In-Store Internet Connected Terminal (300) is wireless, then at some point the wireless network would connect via a gateway to the public Internet.

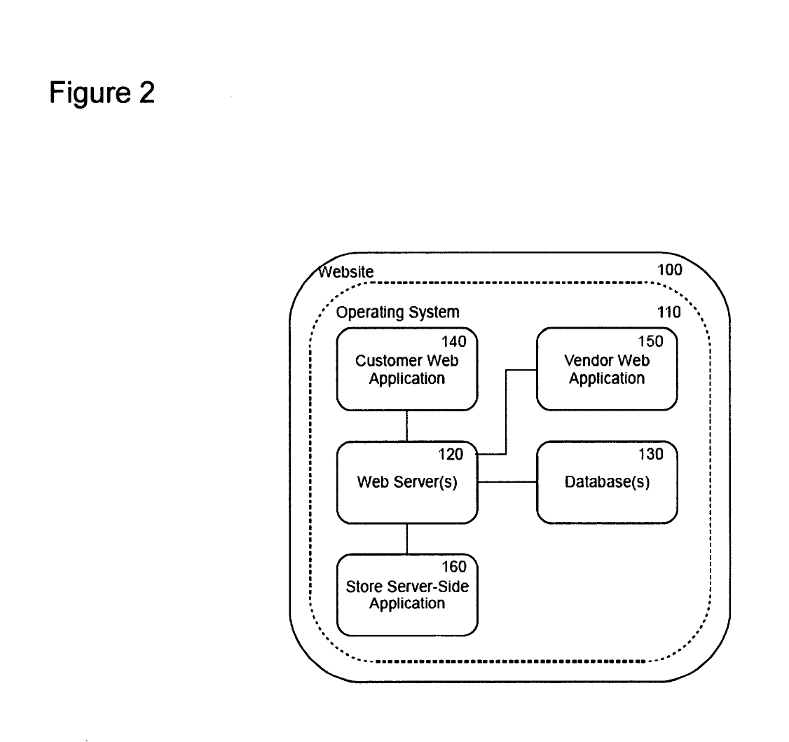

The schematic of the website (100) is depicted in FIG. 2. This figure identifies the various components comprising the website (100) including: the operating system (110) on which the web server(s) application (120) and database(s) application (130) runs/sits along with the three applications of Customer Web Application (140), Vendor Web Application (150), and the Store Server-Side Application (160) to which the In-Store Internet-Connected Terminal (300) ultimately communicates.

One or more vendors will use the Vendor Web Application (150) on the website to open an account and have all or a portion of their respective product and/or service catalogs/menus hosted on the Website (100). Each will have a password protected account and will register one or more store locations. One or more In-Store Connected Terminals (300) will be installed at each such registered store location. The Website's Vendor Web Application (150) will allow a vendor to manage his/her account, including modifying catalog/menu selections, adding and managing data related to registered stores, managing available stock keeping units, reporting on recent purchases and making related information available to personnel at each related store location (e.g., in the case of chains or franchises).

In order to utilize the Invention, a customer will register by visiting the Website's Customer Web Application (140), opening a password protected account, establishing a means of identification, and creating and funding a customer account (which can be further funded in the future). The website will allow the customer to locate participating vendors and stores. The customer may choose one or more products as his/her pre-selection for each participating vendor; potentially, the opportunity to confirm for fulfillment more than one such pre-selection for any given in-store transaction will be offered, though it is anticipated that customers will not have the ability to pre-select many combinations of products, as customers faced with too many choices during the order initiation process would likely slow the process and negate some of the time-saving benefit of the Invention. By visiting/returning to the Website's Customer Web Application (140), the customer may change his/her pre-selection(s) for any participating vendor as often as he/she wishes. Additionally, order history may be available on the website.

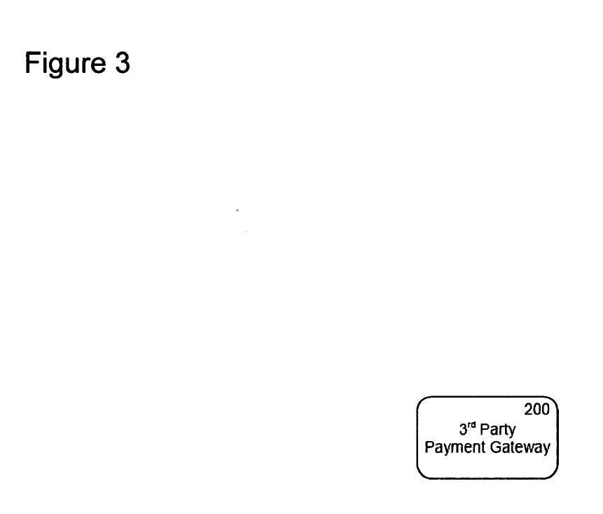

FIG. 3 is a schematic design which depicts the Third Party Payment Gateway (200). The Invention will allow a customer to fund his/her account from a variety of sources that may include without limitation credit card, direct debit (from a bank account), PayPal, or other payment forms (such as RFID built within a mobile phone). Certain components of the funding/payment process will likely be outsourced to a third-party.

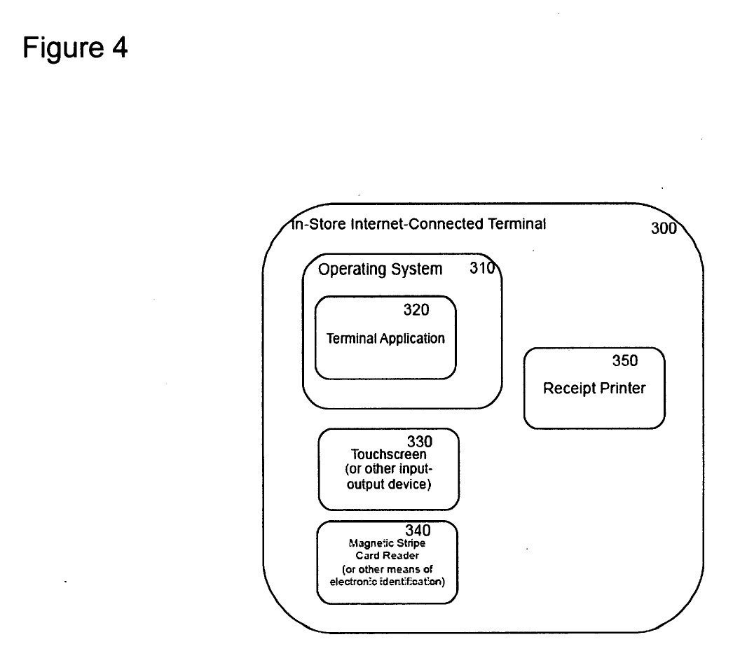

The In-Store Internet Connected Terminal (300) depicted in FIG. 4, consists of an operating system (310), terminal application (320) which is the store-side of the application that interacts with the Store Server-Side Application (160), magnetic stripe/card reader/or other means of electronic identification (340), touch-screen or other input-device (330), and may also consist of one or more receipt printers (350). The terminal application (320) is designed to be easy and quick to use. A customer (a) swipes a credit card or other card with a terminal-readable identifying stripe that may serve as identification such as a debit card, government issued ID, etc., or undergo a different electronic identity confirmation process and then (b) enters a Personal Identification Number or is identified by some other electronic means. If the customer is recognized, then that customer's pre-selected order(s) is/are displayed along with customer's option to either process the/an order or cancel the request without being charged. If the customer is not recognized then the customer is so informed and the request is not processed.

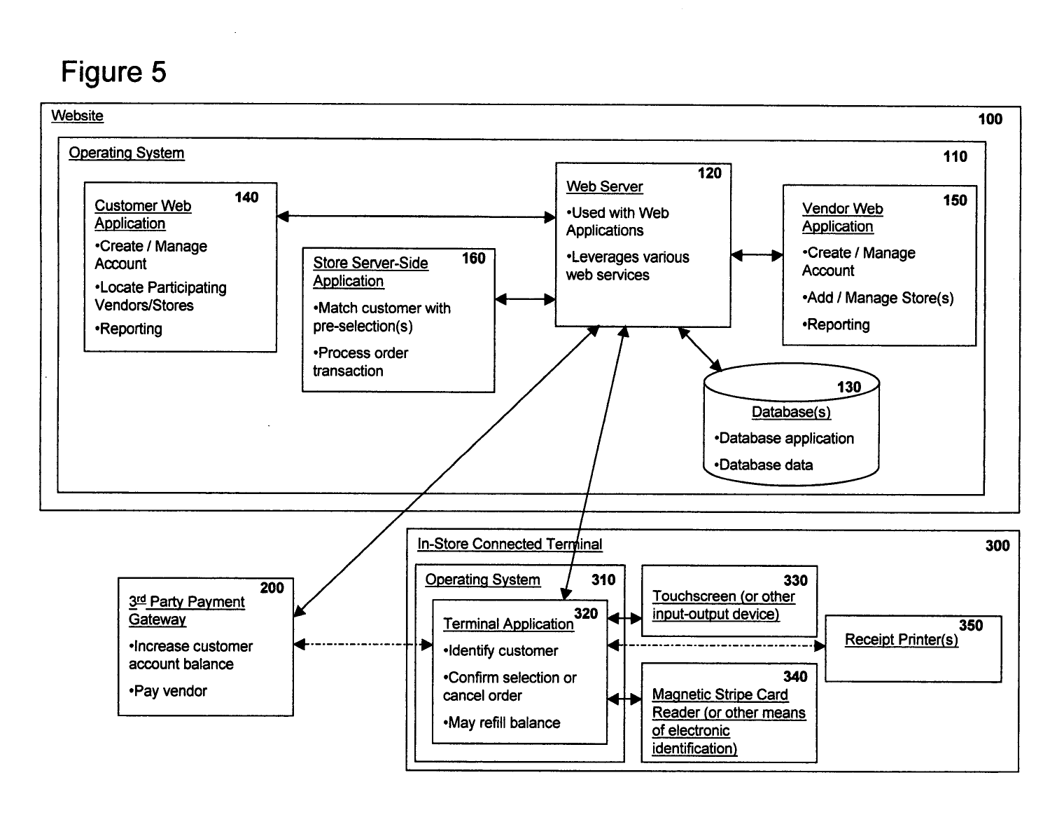

FIG. 5 is a high-level, functional view of the system. As such it displays how the website (100) will extend functionality to a customer to manage accounts through its Customer Web Application (140). This application will allow for but not be limited to (a) account creation/management (which includes managing such information as pre-selection(s), registration of a credit card, debit card, government ID or other “means of identification”, password management, and increasing account balance), (b) locating participating vendor/stores, and (c) reporting on transaction/order history.

FIG. 5 also displays how the website (100) will extend functionality to a vendor to manage accounts through its Vendor Web Application (150). This application will allow for but not be limited to (a) account creation/management (which includes managing such information as catalog/menu items and registered employees' logins and passwords), (b) add/manage stores (which includes adding registered stores, removing registered stores, and managing the catalog/menu items at the store level when appropriate), and (c) reporting on transaction/order history.

FIG. 5 also displays how the Terminal Application located in the store (320) works in conjunction with the offsite/remote application known as the Store Server-Side Application (160) to allow for but not be limited to (a) identifying a customer along with vendor and store location (i.e., the Terminal Application (320) likely hashes or encrypts the “means of identification” registered by the customer, transmits this along with the vendor and store ID to the Store Server-Side Application (160) for matching), (b) presenting the customer with available pre-selection option(s) (if previously configured by the customer and then available at that vendor/store), (c) possibly allowing the customer to replenish his/her customer account, (d) allowing the customer to either confirm an available pre-selection for ordering (along with a PIN, if applicable) or cancel/abort the transaction and (e) debiting the customer's account balance and providing a means for crediting the vendor's/store's account.

FIG. 5 also displays the Receipt (350) of the order from the Internet Terminal (300). Two receipts may be printed from one or more printers. The fulfillment station receives timely notice of the order through some output device (printer and/or display) and, in most cases, the customer receives a receipt (for expenses, returns, etc.).

On any occasion when a registered customer visits a registered store of a vendor for which that customer has made one or more pre-selections, that customer need not wait in the traditional order line to place his/her order. Instead, the customer may proceed directly to a terminal and swipe/enter the registered magnetic-stripe card (or undergo a different electronic identity confirmation process) using the pre-established “means of identification”. The “means of identification” is hashed or otherwise encrypted and communicated along with the vendor and store identification to the Website (100) where interaction with the Store Server-Side Application (160) matches these values with those stored in its Database(s) 130.

Once the customer's identity is established, the description of his/her pre-selection(s) for that store/vendor (previously configured by that customer through his/her customer account) is communicated back to the Terminal Application (320) and displayed on the Touchscreen (or other output device) (330) along with the price of the items comprising the pre-selection(s) (except in the case of a pre-selection that is not available at that store location in which case the customer would be so notified) for that vendor/store. Provided there are sufficient funds in the customer's customer account, the customer will be prompted to confirm or (if the customer has configured more than one pre-selection related to that vendor/store) choose the desired pre-selection.

If the customer confirms/chooses a pre-selection, the terminal will transmit a subsequent communication back to the Store Server-Side Application (160) comprised of the hashed or otherwise encrypted result of the “means of identification”, PIN (if applicable), confirmed pre-section choice's code (if applicable), vendor and store location identification, and confirmation transaction code. Immediately upon confirmation of a successful purchase request, the Invention will (a) return a purchase confirmation message at the terminal, (b) print or otherwise communicate the requested purchase to appropriate store personnel so that the order can be filled, (c) debit the customer account by the cost of the order and (d) credit the vendor account with the appropriate sum (or properly account for the transaction so that such credit will be applied later). If the customer cancels the order before confirming it at the terminal or if his/her customer account has insufficient funds (and the customer chooses not to or is unable to increase his/her account balance while at the terminal, if such choice is provided), then (a) such information will be conveyed at the terminal, (b) no order fulfillment information will be provided to store personnel, (c) the customer account will not be debited and (d) the vendor account will not be credited with respect to the aborted transaction at any time.

What is claimed is:

1. A system for enabling a customer to pre-select one or more “favorite” orders, which order(s) can then be placed and fulfilled in an expedited manner, said system comprising:
an Internet based website(s) comprising;
an operating system(s), web server(s), and database(s);
said database further comprising a database application and data;

2. the website(s) of claim 1 further comprising a customer web application(s), vendor web application(s), store server-side application(s);

3. the system of claim 1 comprising
one or more in-store terminals;
said in-store terminal(s) further comprising an operating system(s), input and output devices;
said in-store terminal(s) further comprising a terminal application(s);

4. The system of claim 1 further comprising a payment gateway(s);
said gateway may be owned or operated by a third-party;

5. The customer web application of claim 2 extending functionality to a customer;
said functionality comprising customer account management, vendor/store location, and reporting;
said customer account management further comprising managing such information as pre-selection(s), registration of a credit card, debit card, government ID or other “means of identification”, password management, and increasing account balance;

6. The said vendor web application of claim 2 extending functionality to a vendor
said functionality comprising vendor account management, store management, and reporting;
said vendor account management further comprising managing such information as catalog/menu items and registered employees' logins and passwords;
said store management further comprising adding registered stores, removing registered stores, and managing the catalog/menu items at the store level when appropriate;

7. The store server-side application of claim 2 along with the terminal application of claim 3 together extending functionality to a customer
said functionality comprising customer, vendor, and store identification
said functionality also comprising presentation of customer with available pre-selection options (favorites), ability to order one or more of these favorites (with the fulfillment station receiving timely notice of the order), possibly allowing the customer to replenish his/her customer account, allowing the customer to confirm a favorite(s) order or cancel/abort the transaction, and debiting the customer's account balance and providing a means for crediting the vendor's/store's account.
